(19) United States
(12) Patent Application Publication
(10) Pub. No.: US 2023/0035058 A1
(43) Pub. Date: Feb. 2, 2023

(54) Techniques For Booting A Compute Integrated Circuit Using A Boot Management Controller In A Processing Integrated Circuit

(71) Applicant: Intel Corporation, Santa Clara, CA (US)

(72) Inventors: Md Altaf Hossain, Portland, OR (US); Mahesh Kumashikar, Bangalore (IN); Ankireddy Nalamalpu, Portland, OR (US); Sreedhar Ravipalli, Cupertino, CA (US)

(73) Assignee: Intel Corporation, Santa Clara, CA (US)

(21) Appl. No.: 17/954,698

(22) Filed: Sep. 28, 2022

(51) Int. Cl. G06F 9/4401

(52) U.S. Cl. CPC G06F 9/4403

(57) ABSTRACT

A circuit system includes a first integrated circuit and a second integrated circuit that includes a boot management controller circuit. The boot management controller circuit provides boot code to the first integrated circuit in response to the circuit system powering up. The first integrated circuit performs a boot operation using the boot code received from the boot management controller circuit.

### FIELD OF THE DISCLOSURE

The present disclosure relates to electronic circuit systems, and more particularly, to techniques for booting a compute integrated circuit using a boot management controller in a processing integrated circuit.

### BACKGROUND

Configurable logic integrated circuits can be configured by users to implement desired custom logic functions. In a typical scenario, a logic designer uses computer-aided design tools to design a custom logic circuit. When the design process is complete, the computer-aided design tools generate configuration data. The configuration data is then loaded into configuration memory elements that configure configurable logic circuits in the integrated circuit to perform the functions of the custom logic circuit. Configurable logic integrated circuits can be used for co-processing in big-data or fast-data applications. For example, configurable logic integrated circuits may be used in application acceleration tasks in a datacenter and may be reprogrammed during datacenter operation to perform different tasks.

### BRIEF DESCRIPTION OF THE DRAWINGS

FIG. 1 is a diagram that illustrates an example of a processing circuit system that includes a compute integrated circuit (IC) and a processing integrated circuit (IC).

FIG. 2 illustrates details of an example of the processing integrated circuit of FIG. 1, according to an embodiment.

FIG. 3 illustrates an example of a datacenter that includes the processing system of FIG. 1.

FIG. 4 is a diagram of an illustrative programmable (i.e., configurable) logic integrated circuit (IC) that may be programmed according to a user design.

### DETAILED DESCRIPTION

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

This disclosure discusses circuit systems that can be implemented in integrated circuit devices, including configurable (programmable) logic devices such as field programmable gate arrays (FPGAs). As discussed herein, an integrated circuit (IC) may include hard logic and/or soft logic. As used herein, “hard logic” generally refers to circuits in an integrated circuit device that are not programmable by an end user. The circuits in an integrated circuit device (e.g., in a configurable IC) that are programmable by the end user are referred to as “soft logic.”

A server computer in a datacenter can include one or more host processors and one or more coprocessors that function as acceleration devices. The host processor may be tasked to perform a pool of jobs/tasks. In order to improve the speed at which these tasks are performed, one or more of the coprocessor integrated circuit (IC) dies can be used to perform a subset of the pool of tasks. The host processor can send acceleration requests to one of the coprocessor IC dies. The coprocessor IC die functions as an accelerator circuit.

Hardware acceleration devices may be used for co-processing in big-data, fast-data, or high performance compute (HPC) applications in one or more server computers in a datacenter. By offloading acceleration functions (e.g., computationally intensive tasks) from a host processor to one or more coprocessors that function as acceleration devices, the host processor is freed up to perform other critical processing tasks. The use of hardware accelerators can therefore help deliver improved speed, latency, power efficiency, and flexibility for acceleration functions, such as cryptography, end-to-end cloud computing, networking, storage, artificial intelligence, autonomous driving, virtual reality, augmented reality, gaming, and other data-centric applications. An acceleration device may be a programmable logic integrated circuit (IC), such as a field programmable gate array (FPGA) that contains soft logic circuitry programmed to perform acceleration functions for a host processor, an application specific IC (ASIC) that contains hard logic circuitry designed to perform acceleration functions for a host processor, or an IC that combines soft and hard logic circuitry. Accelerator devices can be used in server computers to perform networking functions for packets of data that are transmitted to the server computers through one or more networks. The accelerator devices can use compute processing devices, for example, to set up routing for new packets of data that are transmitted to the server computers through a network.

According to some examples disclosed herein, a processing circuit system includes a processing integrated circuit and a compute integrated circuit that performs computations for the processing integrated circuit. The processing integrated circuit can, for example, have a boot management controller circuit and boot memory. The boot management controller circuit provides boot code, e.g., from the boot memory, to the compute integrated circuit after the processing circuit system has powered up. The compute integrated circuit uses the boot code to perform one or more boot operations after (or during) each power-up cycle of the processing circuit system. The boot operations can, for example, load other software into memory in the compute integrated circuit so that the other software can be executed by the compute integrated circuit.

Throughout the specification, and in the claims, the term “connected” means a direct electrical connection between the circuits that are connected, without any intermediary devices. The term “coupled” means either a direct electrical connection between circuits or an indirect electrical connection through one or more passive or active intermediary devices. The term “circuit” may mean one or more passive and/or active electrical components that are arranged to cooperate with one another to provide a desired function.

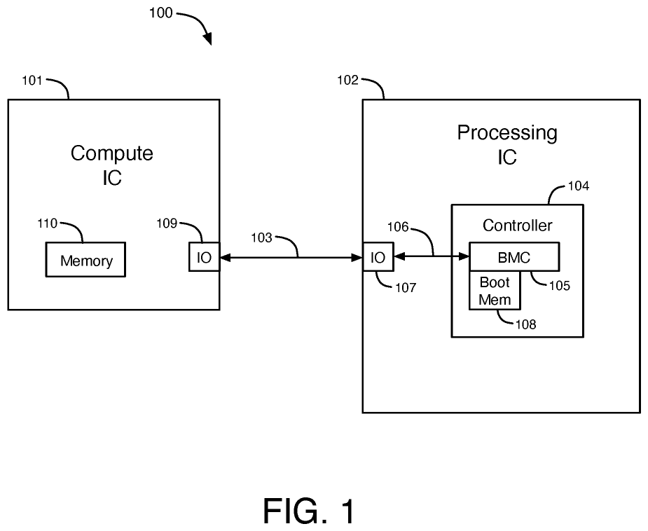

FIG. 1 is a diagram that illustrates an example of a processing circuit system 100 that includes a compute integrated circuit (IC) die 101 and a processing integrated circuit (IC) die 102. The compute IC 101 can be, for example, a processor integrated circuit (IC), such as a microprocessor IC or a microcontroller IC, that performs specialized computations for the processing IC 102. The processing IC 102 can be, for example, a programmable logic integrated circuit (IC), such as a field programmable gate array (FPGA) or a programmable logic device (PLD), a microprocessor IC, a central processing unit (CPU) IC, or a graphics processing unit IC. The processing IC 102 can, for example, be an accelerator device or a co-processor for a host processor.

In the example of FIG. 1, the processing IC die 102 includes a controller circuit 104 and an input/output (IO) circuit 107. The controller circuit 104 in processing IC 102 can, for example, provide robust, secure, and fully authenticated configuration of programmable logic circuits in IC 102 that have configurable features. The controller circuit 104 can allow a user of IC 102 to customize device configuration (e.g., act as a configuration manager or configuration controller). The controller circuit 104 can also perform other functions including, for example, responding to single-event upsets in IC 102, providing reactive zeroization of data in IC 102 as a security response, providing key management, storage, and update for encryption of data in IC 102, providing data and/or configuration bitstream encryption and authentication, providing test features, and providing attack protection features.

The controller circuit 104 includes a boot management controller (BMC) circuit 105 and boot memory (mem) circuit 108 (e.g., non-volatile memory). In the example of processing circuit system 100, the compute IC 101 does not have boot code for booting compute IC 101 after processing circuit system 100 powers up. Instead, the boot code used to boot compute IC 101 is stored in processing IC 102, for example, in BMC circuit 105, in boot memory circuit 108, or in memory in another part of processing IC 102. The boot code may also be referred to as a boot loader or boot firmware. In response to the processing circuit system 100 powering up, the BMC circuit 105 accesses the boot code from memory (e.g., boot memory circuit 108). BMC circuit 105 then provides the boot code to the compute IC 101 through on-die interconnects 106, IO circuit 107, external conductors 103, and input/output (IO) circuit 109 in compute IC 101. Each of IO circuit 107 and IO circuit 109 includes input buffer circuits and output buffer circuits. One or more output buffer circuits in IO circuit 107 transmit the boot code received from the BMC circuit 105 via interconnects 106 to one or more input buffer circuits in IO circuit 109 in compute circuit 101 through the external conductors 103. The one or more input buffer circuits in IO circuit 109 transmit the boot code to other circuits (e.g., memory or a processor core) in compute circuit 101.

The compute IC 101 then uses the boot code received from the BMC circuit 105 via IO circuit 107 to perform one or more boot operations after (or during) each power-up cycle of processing circuit system 100. After the processing circuit system 100 has been powered up, the compute IC 101 has no software in its main memory 110. Therefore, the boot code is loaded from BMC circuit 105 in IC die 102 into compute IC 101, as described above, to perform one or more boot operations in compute IC 101. During the boot operations, the boot code loads other software into memory 110 in the compute IC 101 so that the other software can be executed by the compute integrated circuit (IC) 101. The other software can, for example, be loaded into memory 110 in compute IC 101 from external memory outside or inside processing circuit system 100. As other examples, the compute IC 101 can also use the boot code to initialize random access memory (RAM) in compute IC 101, to access non-volatile memory in compute IC 101 or in another device in processing circuit system 100, or to access devices in processing circuit system 100 from which software (such as operating system programs) and data can be loaded into memory 110 in compute IC 101.

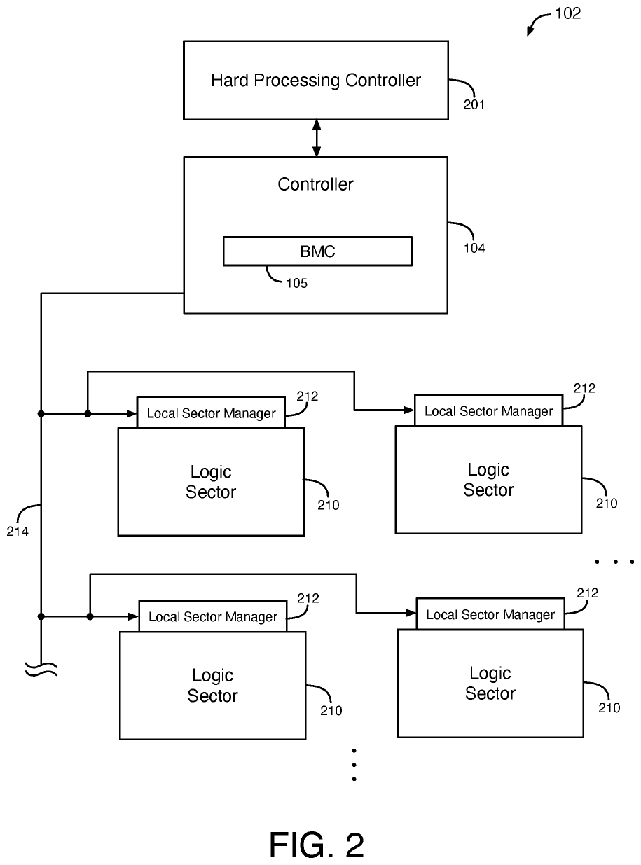

FIG. 2 illustrates details of an example of the processing integrated circuit 102 of FIG. 1. Processing integrated circuit (IC) 102 can be, for example, a programmable integrated circuit, such as, a programmable logic device (PLD) or a field programmable gate array (FPGA). In the example of FIG. 2, IC 102 includes hard processing controller circuit 201, controller circuit 104, multiple logic sectors 210, and multiple local sector manager circuits 212. Each logic sector 210 (e.g., portion or section of logic) can be managed by a respective one of local sector managers (LSM) 212. Local sector managers 212 can be managed by controller circuit 104. Hard processing controller circuit 201 can receive configuration data (e.g., configuration bit streams), requests, and/or commands from a host processor. Controller circuit 104 can receive the configuration data, the requests, and the commands from hard processing controller 201. Hard processing controller 201 can, for example, be a microprocessor or microcontroller. Controller circuit 104 can provide the commands, configuration data, and requests to local sector managers 212 over a bus 214. Bus 214 can be part of a configuration network of conductors. Controller circuit 104 includes the boot management controller (BMC) circuit 105 described above. The particular arrangement of circuits 201, 104, 105, 210 and 212 is shown in FIG. 2 merely as an example that is not intended to be limiting. In other examples, BMC circuit 105 can be in other circuitry in the IC 102, the circuits shown in FIG. 2 can be provided in different arrangements, one or more of the circuits shown in FIG. 2 can be removed from the IC, and/or additional circuits not shown in FIG. 2 can be added to the IC.

Logic sectors 210 can be individually configurable/programmable. Thus, each of logic sectors 210 can independently process different functions in parallel. The parallel processing enabled by logic sectors 210 can be utilized to perform a variety of functions simultaneously by reconfiguring different subsets of the logic sectors 210 to perform the functions. One or more of hard processing controller 201, controller circuit 104, and/or LSMs 212 can function as configuration circuitry that configures programmable logic circuits in the logic sectors 210. Controller circuit 104 or LSMs 212 can store firmware that configures the programmable logic circuits in logic sectors 210 and programmable connections in bus 214 to implement custom functions of a user design for IC 102.

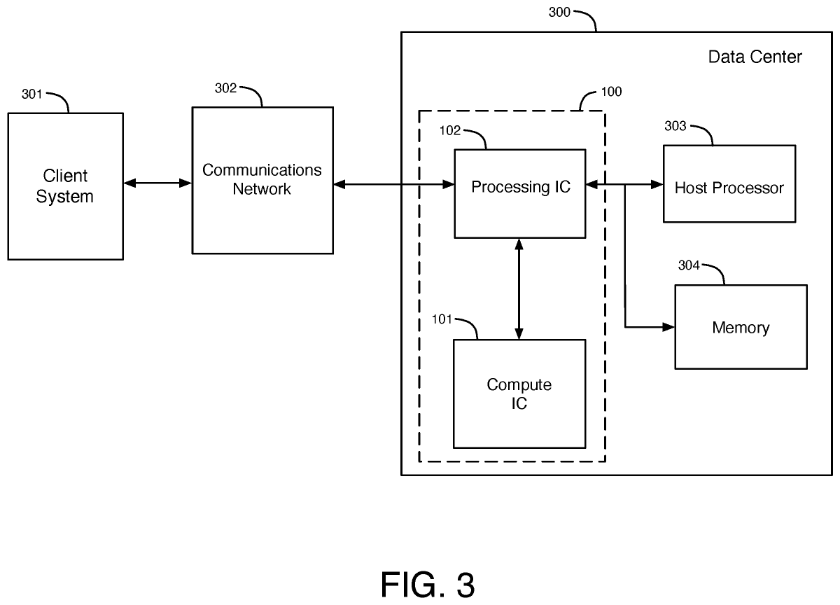

FIG. 3 is a diagram that illustrates an example of a datacenter 300 that includes the processing circuit system 100 of FIG. 1. In the example of FIG. 3, the datacenter 300 includes the compute IC 101, the processing IC 102, and a host processor 303. In the example of FIG. 3, the compute IC 101 and the processing IC 102 are in datacenter 300. The processing circuit system 100 can be, for example, a multi-chip integrated circuit package housing IC dies 101-102, or a circuit board coupled to IC dies 101-102.

The datacenter 300 also includes one or more memory storage devices 304. The components shown in datacenter 300 can be in one or more server computers. FIG. 3 also shows a client system 301 and a communications network 302. The client system 301 transmits packets of data to the processing IC 102 through the communications network 302. The processing IC 102 and the compute IC 101 process the packets of data to generate processed packets of data. The processed packets of data are transmitted to host processor 303 and/or to memory devices 304. Host processor 303 can also generate packets of data that are transmitted to processing IC 102. Processing IC 102 can perform networking functions on the packets of data to generate processed packets of data that are transmitted to the client system 301 through communications network 302.

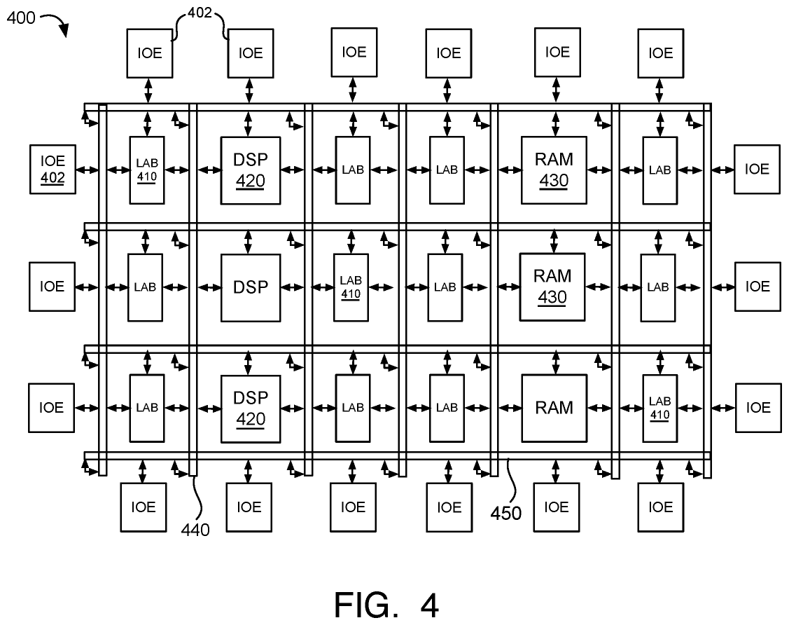

FIG. 4 illustrates an example of a programmable integrated circuit (IC) 400 that can be the processing IC 102 disclosed herein with respect to FIGS. 1-3. Thus, the programmable IC 400 is an example of the processing IC 102 of FIGS. 1-3. As shown in FIG. 4, the programmable integrated circuit (IC) 400 includes a two-dimensional array of configurable functional circuit blocks, including configurable logic array blocks (LABs) 410 and other functional circuit blocks, such as random access memory (RAM) blocks 430 and digital signal processing (DSP) blocks 420. Functional blocks such as LABs 410 can include smaller programmable logic circuits (e.g., logic elements, logic blocks, or adaptive logic modules) that receive input signals and perform custom functions on the input signals to produce output signals.

In addition, programmable IC 400 can have input/output elements (IOEs) 402 for driving signals off of programmable IC 400 and for receiving signals from other devices. Input/output elements 402 may include parallel input/output circuitry, serial data transceiver circuitry, differential receiver and transmitter circuitry, or other circuitry used to connect one integrated circuit to another integrated circuit. As shown, input/output elements 402 may be located around the periphery of the chip. If desired, the programmable IC 400 may have input/output elements 402 arranged in different ways. For example, input/output elements 402 may form one or more columns, rows, or islands of input/output elements that may be located anywhere on the programmable IC 400.

The programmable IC 400 can also include programmable interconnect circuitry in the form of vertical routing channels 440 (i.e., interconnects formed along a vertical axis of programmable IC 400) and horizontal routing channels 450 (i.e., interconnects formed along a horizontal axis of programmable IC 400), each routing channel including at least one track to route at least one wire.

Note that other routing topologies, besides the topology of the interconnect circuitry depicted in FIG. 4, may be used. For example, the routing topology may include wires that travel diagonally or that travel horizontally and vertically along different parts of their extent as well as wires that are perpendicular to the device plane in the case of three dimensional integrated circuits. The driver of a wire may be located at a different point than one end of a wire.

Furthermore, it should be understood that embodiments disclosed herein with respect to FIGS. 1-3 may be implemented in any integrated circuit or electronic system. If desired, the functional blocks of such an integrated circuit may be arranged in more levels or layers in which multiple functional blocks are interconnected to form still larger blocks. Other device arrangements may use functional blocks that are not arranged in rows and columns.

Programmable IC 400 may contain programmable memory elements. Memory elements may be loaded with configuration data using input/output elements (IOEs) 402. Once loaded, the memory elements each provide a corresponding static control signal that controls the operation of an associated configurable functional block (e.g., LAB s 410, DSP blocks 420, RAM blocks 430, or input/output elements 402).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The programmable memory elements may be organized in a configuration memory array consisting of rows and columns. A data register that spans across all columns and an address register that spans across all rows may receive configuration data. The configuration data may be shifted onto the data register. When the appropriate address register is asserted, the data register writes the configuration data to the configuration memory bits of the row that was designated by the address register.

In certain embodiments, programmable IC 400 may include configuration memory that is organized in sectors, whereby a sector may include the configuration RAM bits that specify the functions and/or interconnections of the subcomponents and wires in or crossing that sector. Each sector may include separate data and address registers.

The programmable IC of FIG. 4 is merely one example of an IC that can include embodiments disclosed herein. The embodiments disclosed herein may be incorporated into any suitable integrated circuit or system. For example, the embodiments disclosed herein may be incorporated into numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein may be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein may be stored in non-transitory computer readable storage media. Non-transitory computer readable storage media is tangible computer readable storage media that stores data for access at a later time, as opposed to media that only transmits propagating electrical signals (e.g., wires). The software code may sometimes be referred to as software, data, program instructions, instructions, or code. The non-transitory computer readable storage media may, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Additional examples are now described. Example 1 is a circuit system comprising: a first integrated circuit; and a second integrated circuit comprising a boot management controller circuit that provides boot code to the first integrated circuit in response to the circuit system powering up, wherein the first integrated circuit performs a boot operation using the boot code received from the boot management controller circuit.

In Example 2, the circuit system of Example 1 may optionally include, wherein the first integrated circuit runs the boot code to load software into memory in the first integrated circuit so that the software is executed by the first integrated circuit.

In Example 3, the circuit system of any one of Examples 1-2 may optionally include, wherein the second integrated circuit comprises a security controller circuit that performs security functions for the second integrated circuit, and wherein the security controller circuit comprises the boot management controller circuit.

In Example 4, the circuit system of any one of Examples 1-3 may optionally include, wherein the second integrated circuit is a processing integrated circuit, and wherein the first integrated circuit is a compute integrated circuit that performs computations for the second integrated circuit.

In Example 5, the circuit system of any one of Examples 1˜4 may optionally include, wherein the second integrated circuit further comprises boot memory, and wherein the boot management controller circuit access the boot code from the boot memory.

In Example 6, the circuit system of any one of Examples 1-5 may optionally include, wherein the second integrated circuit further comprises an output buffer circuit configurable to provide the boot code to the first integrated circuit.

In Example 7, the circuit system of any one of Examples 1-6 may optionally include, wherein the second integrated circuit is a programmable logic integrated circuit.

In Example 8, the circuit system of any one of Examples 1-7 may optionally include, wherein the first integrated circuit runs the boot code to access memory in the first integrated circuit or memory external to the first integrated circuit.

Example 9 is a method for booting a first integrated circuit in a circuit system, the method comprising: providing boot code from a boot management controller circuit in a second integrated circuit in the circuit system to the first integrated circuit in response to the circuit system powering up; and performing a boot operation in the first integrated circuit using the boot code received from the boot management controller circuit.

In Example 10, the method of Example 9 may optionally include, wherein performing the boot operation in the first integrated circuit using the boot code further comprises: running the boot code to load software into memory in the first integrated circuit; and executing the software in the first integrated circuit.

In Example 11, the method of any one of Examples 9-10 further comprises: accessing the boot code from boot memory in the second integrated circuit using the boot management controller circuit.

In Example 12, the method of any one of Examples 9-11 further comprises: performing a security function using a security controller circuit in the second integrated circuit, wherein the security controller circuit comprises the boot management controller circuit.

In Example 13, the method of any one of Examples 9-12 may optionally include, wherein providing the boot code from the boot management controller circuit to the first integrated circuit further comprises: transmitting the boot code to the first integrated circuit through external conductors in the circuit system using an output circuit in the second integrated circuit.

In Example 14, the method of any one of Examples 9-13 may optionally include, wherein the first integrated circuit is a compute integrated circuit that performs computations for the second integrated circuit.

In Example 15, the method of any one of Examples 9-14 may optionally include, wherein the second integrated circuit is a programmable logic integrated circuit comprising programmable logic circuits, and wherein the second integrated circuit further comprises a configuration circuit that comprises the boot management controller circuit and that configures the programmable logic circuits.

Example 16 is a circuit system comprising: a compute integrated circuit; and a processing integrated circuit comprising a boot management controller circuit that is configurable to provide boot code to the compute integrated circuit after the circuit system powers up, wherein the compute integrated circuit performs a boot operation using the boot code received from the boot management controller circuit, and wherein the compute integrated circuit performs computations for the processing integrated circuit.

In Example 17, the circuit system of Example 16 may optionally include, wherein the compute integrated circuit runs the boot code to load software into memory in the compute integrated circuit for execution.

In Example 18, the circuit system of any one of Examples 16-17 may optionally include, wherein the compute integrated circuit runs the boot code to access memory.

In Example 19, the circuit system of any one of Examples 16-18 may optionally include, wherein the processing integrated circuit comprises a security controller circuit that performs security functions for the processing integrated circuit, and wherein the security controller circuit comprises the boot management controller circuit.

In Example 20, the circuit system of any one of Examples 16-19 may optionally include, wherein the processing integrated circuit further comprises boot memory, and wherein the boot management controller circuit access the boot code from the boot memory.

The foregoing description of the examples has been presented for the purpose of illustration. The foregoing description is not intended to be exhaustive or to be limiting to the examples disclosed herein. In some instances, features of the examples can be employed without a corresponding use of other features as set forth. Many modifications, substitutions, and variations are possible in light of the above teachings.

What is claimed is:

1. A circuit system comprising:
a first integrated circuit; and
a second integrated circuit comprising a boot management controller circuit that provides boot code to the first integrated circuit in response to the circuit system powering up, wherein the first integrated circuit performs a boot operation using the boot code received from the boot management controller circuit.

2. The circuit system of claim 1, wherein the first integrated circuit runs the boot code to load software into memory in the first integrated circuit so that the software is executed by the first integrated circuit.

3. The circuit system of claim 1, wherein the second integrated circuit comprises a security controller circuit that performs security functions for the second integrated circuit, and wherein the security controller circuit comprises the boot management controller circuit.

4. The circuit system of claim 1, wherein the second integrated circuit is a processing integrated circuit, and wherein the first integrated circuit is a compute integrated circuit that performs computations for the second integrated circuit.

5. The circuit system of claim 1, wherein the second integrated circuit further comprises boot memory, and wherein the boot management controller circuit access the boot code from the boot memory.

6. The circuit system of claim 1, wherein the second integrated circuit further comprises an output buffer circuit configurable to provide the boot code to the first integrated circuit.

7. The circuit system of claim 1, wherein the second integrated circuit is a programmable logic integrated circuit.

8. The circuit system of claim 1, wherein the first integrated circuit runs the boot code to access memory in the first integrated circuit or memory external to the first integrated circuit.

9. A method for booting a first integrated circuit in a circuit system, the method comprising:
providing boot code from a boot management controller circuit in a second integrated circuit in the circuit system to the first integrated circuit in response to the circuit system powering up; and
performing a boot operation in the first integrated circuit using the boot code received from the boot management controller circuit.

10. The method of claim 9, wherein performing the boot operation in the first integrated circuit using the boot code further comprises:
running the boot code to load software into memory in the first integrated circuit; and
executing the software in the first integrated circuit.

11. The method of claim 9 further comprising:
accessing the boot code from boot memory in the second integrated circuit using the boot management controller circuit.

12. The method of claim 9 further comprising:
performing a security function using a security controller circuit in the second integrated circuit, wherein the security controller circuit comprises the boot management controller circuit.

13. The method of claim 9, wherein providing the boot code from the boot management controller circuit to the first integrated circuit further comprises:
transmitting the boot code to the first integrated circuit through external conductors in the circuit system using an output circuit in the second integrated circuit.

14. The method of claim 9, wherein the first integrated circuit is a compute integrated circuit that performs computations for the second integrated circuit.

15. The method of claim 9, wherein the second integrated circuit is a programmable logic integrated circuit comprising programmable logic circuits, and wherein the second integrated circuit further comprises a configuration controller circuit that comprises the boot management controller circuit and that configures the programmable logic circuits.

16. A circuit system comprising:
a compute integrated circuit; and
a processing integrated circuit comprising a boot management controller circuit that is configurable to provide boot code to the compute integrated circuit after the circuit system powers up, wherein the compute integrated circuit performs a boot operation using the boot code received from the boot management controller circuit, and wherein the compute integrated circuit performs computations for the processing integrated circuit.

17. The circuit system of claim 16, wherein the compute integrated circuit runs the boot code to load software into memory in the compute integrated circuit for execution.

18. The circuit system of claim 16, wherein the compute integrated circuit runs the boot code to access memory.

19. The circuit system of claim 16, wherein the processing integrated circuit comprises a security controller circuit that performs security functions for the processing integrated circuit, and wherein the security controller circuit comprises the boot management controller circuit.

20. The circuit system of claim 16, wherein the processing integrated circuit further comprises boot memory, and wherein the boot management controller circuit access the boot code from the boot memory.
